(19) United States
(12) Patent Application Publication
(10) Pub. No.: US 2022/0297977 A1
(43) Pub. Date: Sep. 22, 2022

(54) ELEVATOR SAFETY SYSTEM

(71) Applicant: KONE Corporation, Helsinki (FI)

(72) Inventors: Ari JUSSILA, Helsinki (FI); Atso KOSKINEN, Helsinki (FI); Tommi VAINIO, Helsinki (FI); Toni HIRVONEN, Helsinki (FI)

(73) Assignee: KONE Corporation, Helsinki (FI)

(21) Appl. No.: 17/834,267

(22) Filed: Jun. 7, 2022

Related U.S. Application Data
(63) Continuation of application No. PCT/EP2021/050055, filed on Jan. 5, 2021.

(30) Foreign Application Priority Data
Jan. 9, 2020 (EP) 20150901.5

(51) Int. Cl. B66B 1/34; B66B 5/02

(52) U.S. Cl. CPC B66B 1/3492; B66B 1/3461; B66B 5/02

(57) ABSTRACT

An elevator safety system includes an electronic safety controller running a software including a monitoring mode for monitoring the position of an elevator car within a hoistway. The system includes a position measurement device for measuring the elevator car position. There are limit position identification markers being installed in the hoistway for defining a starting point of a final movement zone in which the car is still allowed to run in a direction to the outermost ends of the hoistway. However, as soon as the end of the final limit zone is reached by the car, an emergency stop is triggered. The position data for the final limit zone are laid down in a memory of the safety controller as parametrized data for being able to adjust them if so needed. Therewith, it can be avoided that the hardware components in the shaft have to be replaced.

### FIELD OF THE INVENTION

The present invention relates to a safety system by means of which the movement of an elevator is monitored especially in view of situations where an elevator car reaches final limit positions in an elevator shaft/hoistway. The invention includes the safety system as such as also a method for running a safety mode along with a software program being run on a computer readable medium.

### BACKGROUND OF THE INVENTION

Each elevator system usually comprises a safety system which is configured to monitor and check the operation of the elevator in order to stop any further movement of the car in case an unsafe condition of the elevator system occurs. This is especially the case when the elevator car is outside of allowable speed limits or a door remains open while leaving a door zone. A further situation in which the elevator runs outside the normal operation mode can be one when the car passes allowable position limits at the upper end of the hoistway or at the bottom pit. These position limits are dependent from the running mode of the elevator. For example, in the maintenance mode, in which situation a person must be allowed to enter the shaft for a maintenance or repairing work, there must be a safety space for the staff upside the car or down in the pit of the shaft. In these cases, there must be other upper and/or lower limits for allowing the car to be positioned at, compared to a normal operation mode in which such safety spaces are not needed. Therefore, an elevator system must have final limit switches to define extreme limits for the elevator car allowing it a maximum movement in the elevator hoistway.

Such a final limit switch is connected to the elevator safety chain to trigger a stop of the car in case it seems that the car moves further on as it actually is allowed by arriving at the area of said final limit switch. Triggering a switch in the form of an electromechanical limit switch is realized by a mechanical ramp which is mounted in the elevator shaft, either close to the pit and/or close to the upper end of the shaft. It is disposed such that the limit switch of the car opens when the car arrives at the mechanical ramp. Opening of the final limit switch causes then the stopping of the car which is realized by interrupting the power supply to the elevator motor and applying the brakes accordingly. The mechanical ramp must be positioned such that the limit switch opens before the elevator car hits the safety buffer which is the final safety measure in the shaft. The safety buffer is a kind of bumper on which the elevator car inevitably hits, should the brake and decoupling of the motor from the current show no effect.

Alternatively, a final limit switch can also be an electromagnetic limit switch. Then a magnet is fixedly mounted in the shaft, wherein the elevator car is equipped with a reader that recognizes the magnet when the car arrives to such a reading position. The installation can also be turned around, meaning that the elevator car carries the final limit magnet, whereas the reader is mounted in the shaft.

As regards the placement of the mechanical ramp or the magnet within the shaft, it is normally not so easy to realize a fixation that fulfils the requirements for the high-precision measuring result being generally needed for the indication of that the car reaches a final limit area. Once installed it is also difficult to realize any adjustment of its position in the shaft what is anyhow difficult and time-consuming. On the other hand, a position adjustment is definitely needed in cases where the car for example hits the buffer before the final limit switch has been triggered. However, there are always mounting tolerances and/or dimensions of the pit safety equipment—as these are for example the safety buffers—that lead to such situation where the car hits the buffer before the final limit switch is able to operate. In these situations, the buffer operating position and/or the final limit switch position need to be adjusted. In even some cases there is no room for any position change of the final limit switch. Thus, it may be necessary to shorten the buffers or even order customary buffers for the installation, or even mechanically deepen the pit.

In prior art, it is known example from document EP3366627A1 to monitor the elevator car position in the elevator shaft with electronic monitoring means comprising a position sensor that can be an acceleration sensor from a car or a position sensor which interacts with markers installed along a wall of the hoistway. The safety system as described therein includes a limit setting unit which is configured to determine an operation status of the elevator to set and define the position limits according to this status. Further, document EP 2 578 526 A1 discloses a position measurement for the car by means of a pulse encoder along with a position detection by marker-plates being installed in the shaft along the normal run-distance of the car in the shaft. By means of the latter a calibration of the actual position of the car gained by the encoder shall be realized. Those positions at which conventionally a limit switch for a start of a final movement zone is to be installed in the shaft are considered by storing relevant position-data in a memory of a safety controller. After passing the last marker-plates, any movement of the car within said following final movement zone then has to rely on the encoder data.

It is thus an object of the present invention to solve the above identified problem to gain a more accurate safety system especially in view of any readjustment of triggering an indication that the elevator car exceeds its allowed limit positions.

### SUMMARY OF THE INVENTION

The object is achieved by constituting an elevator safety system according to main claim 1. The latter is modified with respect to convenient embodiments according to the subordinate claims referenced thereto. Further, there is an elevator system according to claim 13 comprising said safety system and a method for running the safety controller according to claim 14. Finally, there is a computer program claim as claim 21.

Background of the invention is to replace the physical position of at least those markers in the hoistway of an elevator that are constituting the running ends for the car by “position data” and to store these position data in a memory of a safety controller as starting points for a final movement zone for the car. This makes it possible to keep the position adjustable at which an emergency is triggered by the safety controller. In other words: It is the data as transmitted by the hardware components which are taken to trigger the emergency instead of the physical position of the respective switch hardware in the hoistway itself. Then however, there is a need to verify the position of the car in such final movement zone safely even in case a power failure occurred or any computer system component had to be shut down or is restarted. Basic idea of the present invention is therefore to identify the absolute position of the car even within the final movement zone—what is gained by that the whole final movement zone is covered along its length with a possibility to identify the position of the car by detecting a physical marker installed in the final movement zone.

This means in other words that there are no “empty” or “white” areas in which a positioning of the car cannot be verified. In case an elevator car is travelling in the final movement zone and mains electricity power is suddenly interrupted, a stop of the car is caused and the actual encoder data are lost within the final movement zone. In that case, when the electricity supply is resumed again, the system will no longer know the relative position data from the encoder but nevertheless the system exactly knows the car's position within the final movement zone as the position identification marker is present therein, providing absolute position data of the car.

This feature is realized according to the invention by that the limit position identification marker comprises a scale-device—in the following cited as “scale”—for measuring the absolute position of the elevator car in any position of the car within the final movement zone. Once the car reader moves along said limit position identification marker, i.e. when a reader device of the car faces said marker, said absolute position can be gained by means of the scale. Further, the installation position data of said limit position identification marker comprising the scale is stored in a memory of the safety controller as parametrized position data for being able to adjust said position data in the memory.

The scale in question aims for determining the absolute linear position of the elevator car within the final movement zone. As an example for such scale, there can be installed a magnetic marking piece that is the trigger for identifying the start of the final movement zone. Said marking peace is fitted in the shaft to be readable by a position identifier constituted by a reading device that comprises Hall sensors for example. The marking piece is of magnetic material with two consecutive magnetic areas the magnetic poles of which consecutive magnetic areas are made to be of opposite directions to each other. The magnetic areas are arranged at a determined distance from each other in the direction of movement of the elevator car. The Hall sensors in turn are fitted consecutively at the car site in the direction of the movement of the car and they form the reading device. When the measuring device arrives in the proximity of the marking piece the Hall sensors register a change in the magnetic field. When the reading device moves past the marking piece, each Hall sensor forms a proportional signal to the magnetic field of the marking piece in relation to the position. The perpendicular distance between the marking piece and the Hall sensors is in this case at most approx. 30 mm, and most preferably between approx. 10 mm-15 mm. The phase difference between the signals is caused by the interplacement of the Hall sensors. Since the aforementioned signals are essentially sinusoidal in relation to the position, the instantaneous linear position of the elevator car can be determined as the absolute position of the car on the basis of the instantaneous values of the signals, e.g. with trigonometric calculations.

To this end, the elevator safety system according to the invention comprises a programmable electronic safety controller that runs a monitoring software. By means of said software a monitoring mode can be activated for monitoring the position of an elevator car within its hoistway. When running said mode, the monitoring provides data in view of the elevator car's absolute linear position and also in view of that the position is within the limits as set by the data linked to the final limit positions.

When in the following it is about “limit position identification marker” that define a respective starting point for the final movement zone of the car at the outermost ends of the hoistway, these markers can be the terminal floor markers of an outermost floor in the hoistway, respectively. Such marker, however, can also be used in combination with an additional separate end marker or several separate end markers per each end of the hoistway, named in the following also final limit marker, such that a combination of a terminal floor marker of the outermost floor with the one or more additional separate final limit marker(s) constitute the “final limit marker”.

As a starting point for preparing the realization of the inventive concept, an adjustable final movement zone is established where the final limit markers actually trigger an emergency. Because now by means of the invention, it is not the recognition of one of these final limit markers that triggers an emergency stop of the car but the movement of the car is monitored to reach the end of the final movement zone and then further on when being within the final movement zone. According to the invention, the recognition of the final limit marker is the starting point for the further final movement zone the car is allowed to pass, wherein the end of this final movement zone is dedicated by a value verified on the scale and laid down in the memory of the safety controller and output by the program. The final limit markers installed at the outermost ends of the shaft are thus defining the starting point for the further allowed movement of the car, respectively. To hold this final movement zone adjustable, at least the position data of the final limit markers for defining said final movement zone are stored in the memory of the safety controller as parametrized position data. By amending the parameter of the parametrization values said final movement zone is kept variable. As regards a realisation of such amendment, this can be accomplished by means of an interface that gets access to the safety controller and thus to the data laid down in the memory of the same.

The generation of the emergency stop can be made dependant from the respective driving mode in which the elevator runs. For example, in the normal operation mode, the limit-values for the allowable final movement zone are different from the limit-values which are set for the maintenance mode. In the maintenance mode, the limit-values are narrower over the length of the shaft so that the remaining space at the upper end and/or the remaining space in the pit is larger. This is because in the maintenance mode there must be a safety space into which the maintenance person can enter. In the normal operating mode, there are other limits which allow a longer distance to be passed by the car in the hoistway.

Further, the elevator safety system comprises a position measurement device adapted to measure or calculate absolute linear position data of the elevator car within the elevator hoistway. A position sensor included in the device is configured for providing a position value indicating the current position of the elevator car while moving along the hoistway. The position determination for the car is inter alia necessary to provide the safety controller with information whether or not the car's position is within the final movement zone allowed for a further movement of the car. Such position measurement device can encompass a speed sensor which is issuing a speed value indicating a current speed of the elevator car while moving. Then, the position of the elevator car can be determined by integrating the speed measured by the speed sensor. The position data can also be gained by an acceleration sensor, meaning that the position can be calculated by integrating twice the acceleration data. Said acceleration sensor can be also combined with the speed sensor.

In a preferred embodiment, the position measurement device comprises an encoder mounted to a rope pulley of the elevator car. When the pulley rotates, the encoder signal indicates a movement of the elevator car, by means of which a travelled distance of the car can be calculated. The encoder functions as an incremental encoder. Therewith, the position of the car can be established as linear position data in the controller of the elevator system and the safety system.

This calculated position data of the car can be correlated with at least one reference position. Then, the position sensor and/or the acceleration sensor do interact with identification markers—also belonging to the safety system, i.e. the position measurement device—which markers are arranged at a wall of the hoistway to identify for example a landing door zone. Therewith, the elevator car position can be continuously monitored by the controller and the position data as coming from the sensor or the pulley encoder will be adapted or correlated with them. It is possible to lay down some of those position data as coming from the identification markers in a memorized table as fixed position data in the memory of the elevator control. They then can serve as calibration values for the sensor of the position measurement device.

This recalibration can happen every time the reading sensor passes one of the identification markers in the shaft. According to an example, an identification marker can be positioned at each landing, respectively. This combination of sensors and markers realizes that the position of the car can be known not only when receiving the indication of an identification marker at a landing floor level but also during the movement of the car between two markers of them, while the recalibration gains a correction—if needed—to adjust the position data when passing an absolute identification marker position.

As a kind of such identification markers, there can be door zone magnets. These are indicator strips mounted on landing door zones. To this end, the elevator car is equipped with a reader device reading from the magnets the linear position of the elevator car with respect of the landing, respectively. The elevator car position outside of the landings can be measured with the sensors, wherein said measurement information is focused/synchronized with the door zone magnets. In case there is no acceleration sensor or speed sensor or no encoder transferring data for the linear position of the car, this lack is filled with the strip position identification marker giving the linear position of the car along said strip. Within the configuration of the strip position identification marker, there is also a marker for the endpoint of said limit movement zone that is responsible for triggering the emergency stop. The position data of said endpoint-marker is then stored in the memory of the safety controller as parametrized data.

Having a look to the outermost limit position identification markers in the shaft, the same indicate special ranges of the car within the shaft, namely the ones defining whether the car is still within its allowed limits. That is why the position of these limit position identification markers for the final movement limit zone, respectively at the each end of the hoistway, are laid down in the memory of the safety controller as parametrized position data to be able to re-calibrate them in case an error occurs—for example in case the car hits the safety buffer although the output position of the car showed that this should not have happened because according to these data, there should have been a sufficient distance to a buffer. Parametrizing the position of these final markers makes it possible to adjust the final movement zone by determining the value of parametrization. For example, in case the final limit marker starts a final allowed movement zone for the car of further 30 cm—after when passing it an emergency has to be triggered—the position data of the limit position identification marker can be adapted for the final movement zone by amending the parametrized position data in the memory of the safety controller. This makes the 30 cm range of movement allowance variable without actually shifting the physical position of any final limit magnet or final limit switch in the hoistway.

While the final limit marker position is parameterized in any case, it can be decided which further identification marker is categorized to be a parametrized one or which one is laid down in the memory to be fixed one as a calibrating value to calibrate one of the parametrized values. To this end, according to an advantageous embodiment, there are identification markers installed in the hoistway for identifying the position of landing door zones, the positions of which are stored in the memory of the safety controller for calibrating the position data of the car as outputted by the position measurement device. And then even these position data of the identification markers can be stored as parametrized position data in the memory, respectively.

In case the safety controller detects that the buffer contact switch opened due to that the car hit the buffer before an emergency stop is triggered by the safety controller based on that the end of the final movement zone has been already reached, it is determined by the safety controller that there must be an adjustment of the data. This can be realized by adjusting the position data of the limit position identification marker that defines the starting point for the final movement zone. Alternatively, the data of the length of the final movement zone can be adjusted. As a further alternative, the data constituting the end of the limit movement zone can be adjusted. Of course, the above alternatives can be also combined. Then a stuff personnel adjusts the respective position parameter for the final movement zone in the memory of the safety controller. There is a computer program resident on computer-readable media of the safety controller and comprising a set of instructions arranged to cause a computer, or a suite of computers, to help performing the above steps.

According to an embodiment, the safety controller prevents a next run of the elevator until it recognizes that the final limit position parameter has been adjusted. According to another embodiment the safety controller prevents a normal operation until the setup run is successfully passed.

Taking reference to the limit position identification markers being arranged close to the ceiling of the hoistway and near the pit constituting therewith the extreme zone areas, such an identifier may be for example a RFID-identifier or a special magnet associated with the zone magnet. When recognizing one of said final limit activation points by passing it by the car, then, in the safety controller a final limit monitoring check is activated to let the car move further on as defined by the data laid down in the memory for the final moving zone. The limit position identification marker may be extended or accompanied with one or more additional final limit marker(s) such that potential final limit positions can be covered and identified. Said monitoring check means that the safety system handles the task of monitoring the position of the car and of interrupting the electricity supply to the motor and/or of activating the brakes to stop the car if so needed.

All in all, the positioning measurement device can include additional markers which identify different areas of the hoistway. Such markers that also form identification markers support the calibration of the car positioning process. These identifiers can comprise: top end limit identifier of elevator car trajectory; bottom end limit identifier of elevator car trajectory; stopping floor identifier; bottom floor identifier; top floor identifier; servicing space identifier; identifier of reference point between stopping floors.

There can be safety parameters for the top floor and for the lowest bottom floor that can be different and separate from each other to prepare the elevator system that the next markers will be the limit position identification markers. The position of the car can be assessed in millimetres where the final limit becomes active. These safety values can be used for parametrizing the activation points of the emergency triggering. Said safety parameters are normally set at production of the elevator system and can be adjusted with a licensed tool. This is accomplished according to the invention by means of realizing an access to that licensed tool.

On one hand, the position information provided by the position sensor(s)/markers is transmitted to the elevator control. Therewith the movement of the elevator car along the hoistway is controlled by driving for example a drive sheave based on such position information. Elevator safety, on the other hand, requires that the elevator car remains in the area defined by the extreme limits of permitted movement in the elevator hoistway. That is why the car's position information is transferred to the safety system, i.e. the electronic safety controller. To this end, the safety controller continuously polls the position data from the measurement device mounted to the elevator car. This data transfer to the safety system is realized via a safety bus. Since, as said above, the position data is synchronised, i. a. corrected by means of the position data as gained by the door zone magnets in the moment the car arrives at one of them, the safety controller is continuously updated with the actual position of the car. Therewith, the safety controller ‘knows’ about when passing allowed final limits in the hoistway.

The position measurement device as including at least the above markers and reader device components is designed to match the high safety level of the electronic safety controller, such as for example Safety Integrity Level 3 (SIL3) in accordance with the norm EN 81-20; IEC 61508.

The electronic safety controller comprises emergency control means, such as safety relays which are integrated in an elevator safety chain which are known as such. Said safety relays are controlled by a safety software. Opening of one of the safety relays causes a stopping of the elevator car, what is for example realized by interrupting the elevator motor power and by engaging the hoisting machinery brakes. When the measurement data indicate that the elevator car has arrived at a final limit, the safety controller then commands an emergency stop of the elevator by opening one of the above safety relays.

Since the detection of the limit position identification marker of the elevator car means a starting point for letting run a final movement distance before triggering an emergency situation, the final movement distance is laid down in the memory of the safety controller by values which are parametrized, so this final movement distance can be varied on a mathematical basis in a program of the safety controller.

For this reason, the safety controller comprises a memory in which final limit position(s) for the final movement zone are memorized as parametrized values. This adjustment can be accomplished according to a convenient embodiment by means of a manual user interface. Another possibility is an access link or a remote link from e.g. a cloud server. Another alternative is an access link to a remote service centre. An alternative would be a mobile phone on which an application can be run to adjust the data as e.g. memorized in the electronic safety controller.

In the case, when the elevator car hits a safety buffer before having got an indication that one of the final limits has been arrived at, an adjustment must anyhow be carried out. Such a situation shows that an adaptation is needed since the building settings mismatch in dimensioning of the safety buffers or pit structure tolerances or some other installation issues. This is exactly what the invention aims at, namely to correct those items in software or data instead of correcting a hardware component by re-positioning the same physically in the shaft.

According to an embodiment, the method is as follows:

First, the position of an elevator car is recorded by means of a position-measurement-sensor, wherein the position data are transferred to the elevator controller and/or the elevator safety controller. Then, these position data as coming from the position-measurement-sensor are calibrated by means of calibrating data from identification markers within the hoistway and gaining therewith a linear position of the car. The safety controller then monitors by means of the linear position of the car whether the car has passed a limit position identification marker. And if the safety controller detected that the car has passed a limit position identification marker, the safety controller is allocating a final movement zone for a further movement in this direction and triggering an emergency situation in case the end of the final movement zone (i.e. a final limit) has been arrived at by the car. While this is realized the absolute position of the car can be gained at any time during presence in the final limit zone by means of a scale comprised by the final limit position identification marker.

The method can be preceded by further method steps according to a convenient embodiment: Then, there is started a setup run by a controller of the safety system to gather elevator position data. This setup-run is started before the elevator-system is put into operation the first time. Within the setup, the elevator car slowly moves from one extreme position in the shaft to the other one, passing by all floor levels which are to be served later on in the normal use. During this run, the elevator system gathers position data as won by the floor level markers. Some or all of these position data were then laid down as calibrating values into a table stored in a memory of the elevator control. Therewith, the elevator car position can be continuously monitored by the controller and the position data as coming from a sensor or the pulley encoder will be adapted or correlated with them in the upcoming normal operation use of the elevator.

Advantages as gained by the present invention are:
The final limit distance from a terminal floor can be adjusted freely with respect to the terminal floor;
The final limit distance can be defined separately for top and bottom final limits;
A short final limit is available also before an elevator setup has been driven;
There is no need to support a short final limit magnet type, which means lower production costs.
A short final limit distance can be used also with hydraulic elevator and it is possible that a bottom final limit magnet is not required at all.

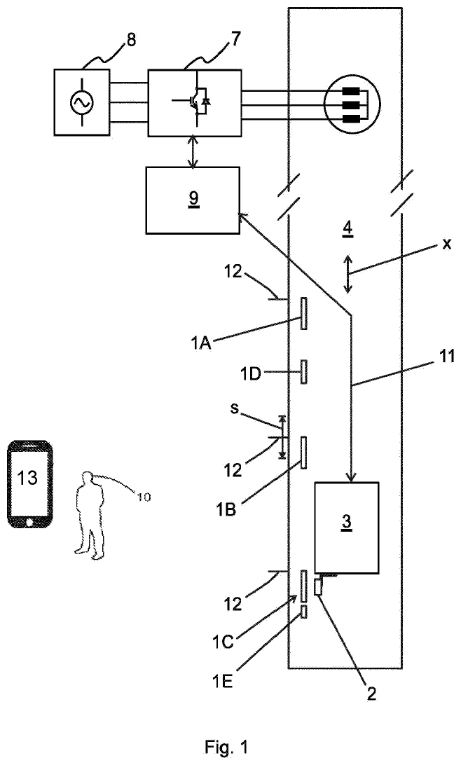

The aforementioned summary of the invention will be better understood by the aid of the following description referenced to the drawing FIG. 1 in which description it is about the final limit area in the bottom part of the hoistway. The same structure is however to be found at the upper part of the shaft in a mirrored configuration.

FIG. 1 presents an elevator, which comprises an elevator car 3, which is adapted to be movable in an elevator hoistway 4 along a trajectory “x”. The elevator also comprises an electric drive 7, for driving the elevator car 3. The elevator car 3 is moved with elevator ropes 22 passing via the traction sheave of the hoisting machine. A frequency converter is controlled with the movement profile calculated by an elevator control unit 9 in such a way that the elevator car 3 transfers passengers according to the movement profile from one stopping floor 12 to another in the manner required by the elevator calls given by the passengers.

A positioning device of the safety system for determining the location of the elevator car 3 is fitted to the elevator. This can be accomplished in that the running speed of the elevator car is obtained by measuring the speed of rotation of the traction sheave of the hoisting machine. Alternatively or additionally, the position measurement device comprises an encoder being mounted to a rope pulley 21 of the elevator car. When the pulley 21 rotates, the encoder signal indicates a movement of the elevator car, by means of which a travelled distance of the car can be calculated. This position calculation for the car is correlated with at least one reference position, such as by means of a door zone magnet at positions of numbers 1A, 1B, of the middle floors and/or at number 1C of the terminal floor. Reference numeral 20 indicates a controller of the safety system of the elevator.

While the elevator control unit needs information about the location of the elevator car for calculating the movement profile, the elevator safety system, on the other hand, requires that the elevator car 3 remains in the area defined by the extreme limits of permitted movement in the elevator hoistway. These types of extreme limits of permitted movement is the bottom end limit position identification marker 1C; optionally in combination with the final limit marker 1E acting then also as a limit position identification marker. Starting from the limit position identification marker 1C there is a further allowable distance the car may move further on defined as final movement zone. The distance and or the position of it is held adaptable since the position data of the limit position identification marker 1C for the final movement zone is laid down in the memory as a parametrized position data that can be amended. In case the final limit marker is an additional one being in combination with the limit position identification marker 1C of the outermost floor, the final limit marker 1E can be also stored in the memory with parametrized position data for being able to adjust it. At least one of such final limit markers comprises a scale by means of which absolute position data of the car can be gained during its presence within the final movement zone.

There are also top end limits of the elevator hoistway—although not shown in the FIGURE.

Independently from them, there can be additionally or alternatively different extreme limits set, too, e.g. for the normal operation mode of the elevator and/or for the servicing mode of the elevator when running it in the maintenance mode.

The positioning device of FIG. 1 comprises permanently-magnetized position identifiers being the markers 1A, 1B, 1C, 1D, 1E, which are disposed in the elevator hoistway 4 by the side of the trajectory of the elevator car 3. The position identifiers 1A, 1B, 1C, 1D and 1E are read with a reader device 2 installed on the elevator car 3 below the car-floor. The reader device 2 detects a position identifier marker 1A, 1B, 1C, 1D, 1E, when the reader device 2 is situated in the immediate proximity of one of them. The position data is transferred from the reader device 2 to the elevator control unit and to the electronic safety controller 20 along trailing cables which include a safety bus 11. The reader device 2 can also be situated elsewhere in connection with the elevator car 3, e.g. on the roof of the elevator car. Said reader also reads the scale as comprised by one of the final markers that are responsible for indicating the starting point for the final movement zone.

Position identifiers indicate the linear position “s” of the elevator car 3, i.e. the linear and stepless varying position data of the elevator car 3 in the measuring range of the position identifier. Exact linear position feedback data “s” is needed e.g. when stopping the elevator car at a stopping floor 12, to make sure that the floor of the elevator car 3 is flush with the floor level 12 in such a way that a step detrimental to passage is not formed between the floor level 12 and the floor of the elevator car 3. Both the position identifier and also the linear position data are coded into the magnetic field of a position identifier. Alternatively or additionally, position identifier may comprise additional identification means, such as RFID tag. Consequently, inter alia, stopping floor identifiers as well as the extreme limit markers required for elevator safety are provided with identifications.

At least the following position identifiers are possible:
bottom end limit identifier of elevator car trajectory
top end limit identifier of elevator car trajectory
stopping floor identifier
top floor identifier
bottom floor identifier
servicing space identifier
identifier of reference point between stopping floors.

The identifier marker 1C of the terminal landing indicates also the beginning of the extreme final movement zone for the final permitted movement of the elevator car in the pit of the elevator hoistway. The length of the final movement zone during normal operation of the elevator is set differently, namely nearer to the bottom end of the elevator hoistway as compared to the maintenance driving mode, for example. The identifier marker of the top end limit is not presented in FIG. 1, but it is disposed nearer to the top end of the elevator hoistway compared to the top floor identifier marker in a corresponding manner as it is with reference to the bottom end limit identifier marker. It also comprises a scale as it is true for the final limit marker of the pit. Further, there may be end limit-values of the final movement zone for the servicing mode in the elevator hoistway 4 final movement zone, so that sufficient safety space and working space for a serviceman remains in the proximity of the ends outside the trajectory of the elevator car 3. In this aspect there may be an additional servicing space identification marker but being also not presented in FIG. 1.

The identifier marker 1D of a reference point between stopping floors 12 may be used to increase positioning accuracy between stopping floors. It may also be used e.g. as a mark of the deceleration point of the elevator car to indicate the point at which the elevator car must start to decelerate when stopping at a floor. The identifier marker 1D can also mark a point that allows a serviceman access from the floor level of a stopping floor 12 to the roof of the elevator car via the hoistway door (i.e. a point where the roof of the car and the floor level are at the same height). Deceleration point markers may be used especially in those embodiments where there is no acceleration sensor or speed sensor or no encoder transferring data for the linear position of the car.

The stopping floor identifier markers 1A, 1B are disposed in such a way that the floor of the elevator car 3 is flush with the floor level 12 when the reader device 2 and the stopping floor identifier marker 1A, 1B are situated facing each other, respectively.

So, the safety system receives continuously the position data of the car via the safety bus 11. In case the elevator car 3 passes the identifier marker 1C there is triggered a monitoring check mode in the safety system 9 for the final movement zone such that the car is still allowed to move a specific distance after which passing an emergency stop is triggered, meaning that the safety system then sends an alarm signal to stop the car. This is realized by interrupting the current to the drive 7 and/or by opening the brakes. This ensures that the car does not hit the buffer (not shown in the Fig.). However, in case the buffer is actually hit without triggering the emergency, it is clear that there must be a correction of the positioning data allocated to marker(s) 1C, 1E since this situation actually should not happen. In other words, the positioning data pretended a position of the car that showed a remaining distance to the buffer although not having been present. Alternatively, the limit zone data are amended in the memory of the safety controller, i.e. the length of the final movement zone and/or the end position of the final movement zone. In some alternative embodiments, the marker 1E is replaced with a mechanical safety switch, providing additional safety in combination with the safety controller-memorized final limit.

In case the data for at least the final movement zone as laid down in the memory of the safety system zo have to be adjusted, the same can be realized by a person 10 on a mobile 13 running an app that enables him to login on the safety controller for amending the parametrization of the positioning data. Alternatively, the allowed distance following the recognition of the final limit marker is amended. By means of this, the physical position of the identifiers, especially the limit markers, in the hoistway can remain unchanged. The adjustment can be also accomplished by a manual user interface—as for example a tablet—or an access link or like a remote link being configured for adjusting the at least one final limit position.

With regard to the first steps before commissioning the elevator, the following procedures may be useful as a convenient embodiment:
Starting a setup-run before putting the elevator-system into operation the first time by moving the car slowly in the elevator shaft 4 between its extreme outermost shaft-positions;
Recording the position of the car 3 by means of a position-measurement-sensor and transferring the position data to the elevator safety controller 20;
Registering the identification markers 1A, 1B, 1D in the memory of the safety controller zo when the car 3 passes them by during its slow movement in the shaft 4, and storing these position data as calibrating data in a memory of the safety controller;
Registering limit position identification markers 1C installed at the terminal landing and defining therewith a starting point for a further allowed movement limit zone of the car, respectively, wherein at least the data of the allowed final movement zone are parametrized and stored in the memory of the safety controller as parametrized position data;
If in a test run an emergency is triggered by the safety controller before the car hits the buffer at one end of the shaft, the normal operation mode can start since the functioning is right,
If, however, in a test run the buffer at one end of the shaft has been hit before triggering an emergency stop by the safety controller, the parametrized data as laid down in the memory of the safety controller have to be adjusted.

To this end, the parametrization of the position data for the final limit zone can be adjusted by means of an interface configured to adjust them.

Finally, the inventive method steps of the normal run in the normal operation mode can be started as monitoring by means of the limit position identification marker(s) 1C; 1E whether the car 3 has passed the starting point of the final movement zone. If the safety controller detected that the car has passed the starting point of the final movement zone, then the final movement zone is allocated for a further movement in this direction. As soon as the end of the final movement zone is identified an emergency stop is triggered then. Otherwise, the movement of the car turns in the other direction and the normal operation mode is continued.

1. An elevator safety system, comprising:
an electronic safety controller running software for monitoring the position of an elevator car within a hoistway;
a position measurement device for measuring the elevator car position, the position measurement device being communicatively connected to the electronic safety controller; and
at least one limit position identification marker installed at one end of the hoistway indicating a starting point for a final movement zone for the car in the direction to the hoistway's end,
wherein the limit position identification marker comprises a scale for measuring an absolute position of an elevator car moving along the limit position identification marker, and
wherein the installation position data of said limit position identification marker is stored in a memory of the safety controller as parametrized position data for being able to adjust said position data in the memory.

2. The elevator safety system of claim 1, wherein a length of the final movement zone is further defined in the memory by means of final end position data corresponding to absolute position data readable from the scale.

3. The elevator safety system according to claim 1,
wherein the safety controller is configured to trigger an emergency stop when the car reaches the final end position of the final movement zone.

4. The elevator safety system according to claim 1, wherein there are two limit position identification markers at each end of the hoistway, each of the markers constituting a respective final limit zone.

5. The elevator safety system according to claim 1, wherein the limit position identification marker is the identification marker of a terminal landing.

6. The elevator safety system according to claim 1, wherein the safety system further comprises one or more final limit markers at one end of the hoistway, respectively, being installed consecutively to the limit position identification marker towards an outermost end of the hoistway, wherein the limit position identification marker in combination with the final limit marker(s) define the starting point of the final movement zone of the car.

7. The elevator safety system according to claim 1, further comprising identification markers installed in the hoistway, the positions of the identification markers being stored in the memory of the safety controller for calibrating the position data of the car as outputted by the position measurement device.

8. The elevator safety system according to claim 7, wherein the position data of the identification markers are stored as parametrized position data in the memory, respectively.

9. The elevator safety system according to claim 1,
wherein means are comprised for adjusting the data in the memory to adapt said movement limit zone.

10. The elevator safety system according to claim 9, wherein the means for adjusting the position data includes include a manual user interface or an access link configured for adjusting said data.

11. The elevator safety system according to claim 1, wherein the position measurement device comprises a reader for reading said at least one limit position identification marker.

12. The elevator safety system according to claim 11, wherein the position measurement device comprises:
an encoder indicating a movement of the elevator car, wherein the position of the car is calculated by mathematically integrating the movement data; and
a signal strips identifier as identification markers configured to indicate linear door zone position data of the elevator car,
wherein said reader is configured for reading said signal strips identifier, and
wherein the electronic safety controller is configured to synchronize the position data as coming from the encoder with the data as issued by the signal strips identifier.

13. An elevator system, comprising the elevator safety system according to claim 1.

14. A method of running a controller of the elevator safety system according to claim 1, comprising the steps of:
monitoring by means of the limit position identification marker whether the car has passed the starting point of the final movement zone; and
if the safety controller detected that the car has passed the starting point of the final movement zone, allocating the final movement zone for a further movement in this direction while monitoring the position of the car within the final movement zone by means of absolute position data deprived by a scale comprised by said limit position identification marker and triggering an emergency stop in case the end of the final movement zone has been identified.

15. The method of running a controller of the elevator safety system according to claim 1, wherein the identification of arriving at the end of the final movement zone is realized by means of the linear position data of the car as being output by the position measurement device corresponding to absolute position data readable from a scale as comprised by the limit position identification marker.

16. The method according to claim 14, further comprising the step of if the safety controller detected that the car has arrived at the safety buffer before the end of the final movement zone, the safety controller is triggering an emergency stop and is requesting an adjustment of the end of the final moving zone data.

17. The method according to claim 16, further comprising the step of preventing an elevator nm until the end of the final movement zone has been adjusted.

18. The method according to claim 14, further comprising the steps of:
recording of the position of the elevator car by means of the position measurement device and transferring the position data to an elevator controller and/or the elevator safety controller; and
calibrating the positioning data as coming from the position measurement device by means of calibrating data from the identification markers within the hoistway and gaining therewith the linear position of the car;

19. The method according to claim 14, wherein before starting the method, the following steps are preceding:
starting a setup-run before putting the elevator-system into operation the first time by moving a car slowly in the elevator shaft between extreme outermost positions of the car in the shaft;
registering identification markers when the car passes the registration markers during movement in the hoistway, and storing the position data in the memory of the safety controller; and
registering limit position identification markers defining the starting point for the final movement zone of the car, respectively, wherein at least the position data of said limit position identification markers or the data of said movement limit zone are laid down as parametrized data and in the memory of the safety controller.

20. The method according to claim 14, further comprising the step of adjusting the end of the final movement zone data by means of an interface that is configured to adjust the end of the final movement zone data.

21. A computer program embodied on a non-transitory computer readable medium and comprising program code adapted to cause the method according to claim 14 to be executed on a data-processing unit of the elevator safety system.
